(19) United States
(12) Patent Application Publication
(10) Pub. No.: US 2015/0379580 A1
(43) Pub. Date: Dec. 31, 2015

(54) DYNAMICALLY SYNCHRONISING MEDIA CONTENT RELATED DATA

(71) Applicant: SUMMIT MEDIA, Yorkshire (GB)

(72) Inventors: Hedley Aylott, Yorkshire (GB); Ben Latham, Yorkshire (GB); Chris Wilson, Yorkshire (GB)

(21) Appl. No.: 14/316,238

(22) Filed: Jun. 26, 2014

(51) Int. Cl. G06Q 30/02

(52) U.S. Cl. CPC G06Q 30/0269; G06Q 30/0275

(57) ABSTRACT

Embodiments of the present disclosure aim to improve upon systems for dynamically adjusting and synchronising online content with offline content. In particular, embodiments of the present disclosure allow for the detection of transmission or broadcast of media content via media channels, and the real-time application of altered online strategy based on factors including the nature of the media content transmitted, the media channel upon which it was transmitted or broadcast, or the location in which it was transmitted or broadcast. Attributes of online content which may be dynamically aligned with the broadcast or transmission of media content include keywords associated with a particular product, or the maximum bid amounts which are to be used in a Pay Per Click (PPC) auction.

### TECHNICAL FIELD

The invention relates to a method and system for synchronising online related content data based on detection of transmission of media content on a media channel.

### BACKGROUND OF THE INVENTION AND PRIOR ART

Many advertisers broadcast multiple advertisements on television and radio channels, since the reach of these channels remains comparatively high, even with the advent, and rise in popularity, of online advertising content. Advertisements may be shown during a commercial break of a television program, or during allocated slots on radio broadcasts, and also may appear on a website which a user is browsing

It is known that once a television viewer has seen an advert, or a radio listener has heard an advert, he or she is more likely to be interested in products relating to the advert, and may use the internet to search for related items. The items that are searched for online may be the products in the advert itself, or may be part of a special offer. Other factors also affect the traffic received by websites accessed either directly or via search engine results pages. For example, following the broadcast of a popular television program relating to home improvement, retailers dealing in related products notice an increase in online traffic.

The normal way in which people find products or services online is via a search engine, such as those provided by Google® or Bing®. results provided when a string of words or phrases is input into a search engine evidently depend on the search terms used. Popular search terms are known as keywords.

Many search engines allow businesses to pay for placing their content at the top of a list of search results, in so called “sponsored links”. In addition to this other prominent space on a webpage is available to retailers, at a premium. The content that is displayed to a web user of a webpage may be tailored to each individual user based on location, browsing history, the search terms used etc., and this space will be available to different retailers or businesses depending on the manner in which the user has arrived at the webpage.

Much of the advertising which appears on webpages works under the Pay per Click (PPC) model. The PPC model is a way for webpage hosts to charge an advertiser a premium each time a visitor of the webpage clicks on an advert containing a link which is displayed on the webpage, and is therefore directed to the webpage of the advertiser. PPC advertising may be implemented on a flat rate or a bid-based basis. An advertiser, known in the online world as a merchant, sets a maximum amount that it is prepared to pay for appearing at a particular location on a webpage, in the case of online display advertising, or for appearing at the top of a series of search results. This is one of the key factors which determine if and where an online advertisement will appear on a webpage.

Since the advertising content that a web user or visitor to a webpage is dependent on the manner in which they reached the site (their location, the search keywords used, etc.), and the behaviour of users is dependent on whether they have seen or heard a broadcast advertisement, it is in a supplier's interest to be able to modify the content that is displayed to a user in real time as advertisements are broadcast. Effectively an online advertiser has some control in choosing when, where and to whom their advertisement appears.

It is known to use device specific application based software to “listen” for related content which is transmitted in a particular location (i.e. a user's living room) or via a particular device, before displaying a corresponding advertisement from that application on a networked device, which may be a computer, tablet device or mobile device.

### SUMMARY OF THE INVENTION

Embodiments of the present disclosure aim to improve upon systems for dynamically adjusting and synchronising online content with offline content. In particular, embodiments of the present disclosure allow for the detection of transmission or broadcast of media content via media channels, and the real-time application of altered online strategy based on factors including the nature of the media content transmitted, the media channel upon which it was transmitted or broadcast, or the location in which it was transmitted or broadcast. Attributes of online content which may be dynamically synchronised with the broadcast or transmission of media content include keywords associated with a particular product, image or video data for use in display advertising, or the maximum bid amounts which are to be used in auctions for online web advertising placement, e.g a Pay Per Click (PPC) auction or similar.

One embodiment of the present disclosure relates to a method which includes the steps of receiving, by a processor on a server, a notification of transmission of predefined media content on a media channel, retrieving media content metadata associated with the transmitted media content from a database, wherein the retrieved metadata relates to products or classes of products relating to the transmitted media content, and the retrieved metadata comprises post-transmission attributes which are selected from a group comprising: keywords, keyphrases, image data, video data and bid data; and transmitting a first message comprising the post-transmission attributes to a remote server, wherein the remote server writes the post-transmission attributes to user-profile data for use by an advertising management system.

Further features and advantages of embodiments of the invention will be apparent from the appended claims.

### BRIEF DESCRIPTION OF THE DRAWINGS

Further features and advantages of the present invention will become apparent from the following description of an embodiment thereof, presented by way of example only, and by reference to the drawings, wherein like reference numerals refer to like parts, and wherein.

FIG. 1 is an overview of an example process according to the present disclosure;

FIG. 2 is a flow chart showing the process of setting up media content for use by a content monitoring system;

FIG. 3 is a flow chart showing the process of predefining media content and assigning associated products and metadata;

FIG. 4 is a flow chart outlining the transmission monitoring process;

FIG. 5 is a flow chart which shows the process of synchronising media content related data, where content is managed via an advertising management system; and

FIG. 6 is a flow chart which shows the process of synchronising media content related data with web content.

### DESCRIPTION OF THE EMBODIMENTS

Media content is broadcast on a variety of different media channels, including television, radio, the internet, etc. Television and radio channels provide users with a schedule of content to be broadcast, which highlights the program content transmitted. There is no schedule of the advertising content which is to be broadcast however.

Advertisers often pay in blocks for their advertisement content to be broadcast, and will not know the exact time that their content is due for transmission.

It is possible to automatically monitor media channels for the content that is being broadcast. Such monitoring is necessary for compliance issues, for example, and is regularly used to verify that content has been broadcast in its correct ratio, or with the correct audio, and that no other errors were present in the transmission.

Monitoring is performed by analysing the content of the digital media to be broadcast.

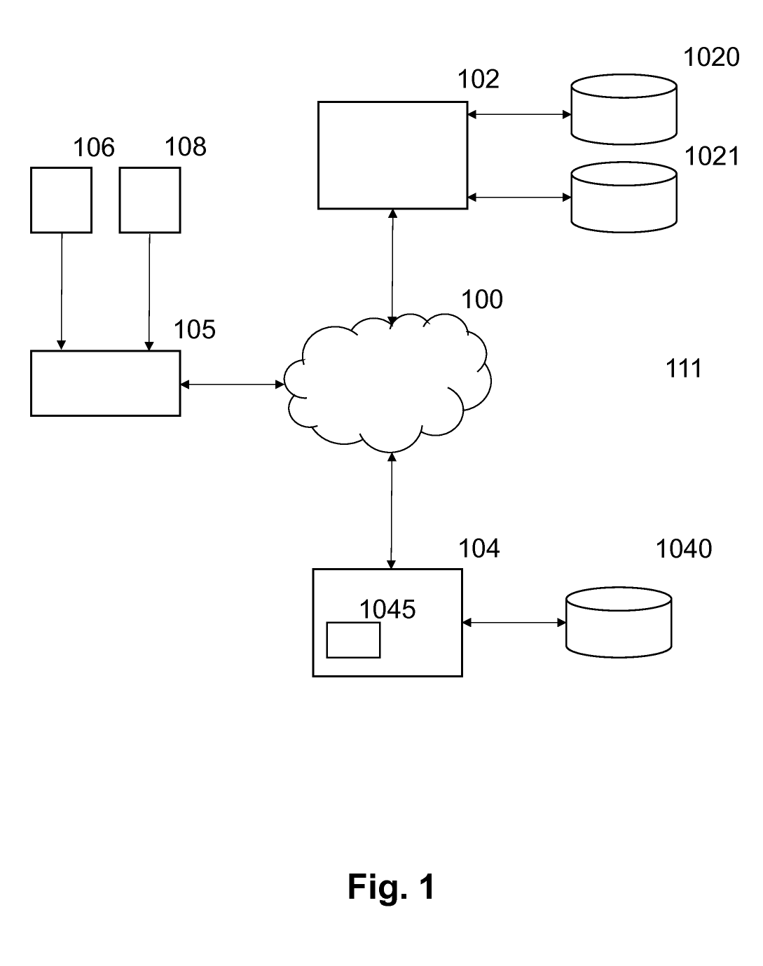

Referring to FIG. 1, FIG. 1 shows a diagram of the key components used in an environment in which a system 111 responds to notification of transmission of media content on a media channel by transmitting a message or messages instructing update of attributes stored on a remote server, which attributes are for use in the operation of an advertising management system 1045.

The environment shown in FIG. 1 includes a network 100, which may be a Local Area Network (LAN), a Wide Area Network (WAN) or the internet. Network 100 allows server 102 to communicate with remote server 104. Server 102 receives notification of transmission of media content on media channels 106, 108 from notification generator 105 via network 100. Server 102 communicates with metadata database 1020, and attribute database 1021. It will be understood that while in FIG. 1 databases 1020, 1021 are shown as distinct entities, that they may make up parts of one single database. Communication between server 102 and remote server 104 via the network 100 may take place through a web-service API.

Metadata database 1020 stores metadata relating to media content. Media content may be video advertising media, audio advertising media, image media, or text media. Video media for broadcast includes advertisements to be shown in commercial breaks between programs on a television channel, and also television programs themselves, or a part of a television program. Audio media may be advertisements to be played out on commercial radio channels, or radio programs themselves. Audio media may also include music content played on radio channels.

Media content may be associated with a particular retailer or business. The media content may relate to a specific product or range of products, or to a specific service or range of services.

Media content may belong to the user or users who wish to monitor the media channels, but equally a user may wish to monitor for media content from a competitor offering similar products and services.

The metadata stored on metadata database 1020 relates to media content associated products or services, and classes of media content associated products or services, known as ad groups. The database may be populated automatically, or may be user-populated. A user may populate the database by choosing adgroups which relate to media content that is to be transmitted on one or more of the media channels. If for example media content is an advertisement which is part of a campaign relating to musical instruments sold in London, adgroups can be created and structured relating to “musical instruments” “stringed instruments”, “woodwind instruments”, “percussion instruments”, and into much further detail, for example “guitars”, “rock guitars”, “vintage guitars”, “vintage 12-string guitars” and so on. Products or services may also be associated with particular media content, either automatically or manually, by a user.

The metadata attributes stored on attribute database 1021 relate to the adgroups and the products or services which are stored in metadata database 1020. Attributes include keywords, keyphrases and creatives. These are explained below.

“Keywords” are words or phrases which people search for using search engines or encounter as they browse websites with themes relating to a particular business. Using the example above, the keywords attributed to particular adgroups may be: “musical instrument shop London”; musical instrument sale London”, “quality woodwind instruments London” and so on.

“Creatives” are product or service associated tools used in marketing campaigns. A creative is any text, hypertext, image content, video content or audio content which may be associated with an online advertisement which may help to entice a potential customer to click on the advertisement to be transported to a landing page where a purchase may be made. An example of a text creative might be “click here to see our fantastic range of guitars”. Again “creatives” can be input into the database manually by a user or they may be created within a computer program and the database automatically populated.

Bid data is also stored on attribute database 1021, as part of the attribute data or separately. Internet-based marketing is often carried out in a bid-based auction environment. For example, when an online user enters a search string into a search engine operated by a search company, the search engine determines which online advertisers having a user account which is managed by an advertising management system 1045 belonging to the search company have identified the keywords contained in the string as relevant. A user must enter a maximum bid amount relating to each ad group identified as relevant in the user profile data that is transferred to the user profile database, depending on their desire to push a particular advertisement to the top of a set of search results, or to ensure an advertisement features prominently on a content webpage. The bids are set at ad group level, not at keyword level. Maximum bid amounts are stored in attribute database 1021.

The data stored in attribute database 1021 is communicated by server 102 to remote server 104 via network 100. Remote server 104 stores user profile data which includes bid data.

Various factors make people more or less likely to search for a particular product or service via a set of keywords, or visit the homepage or website of a retailer, for example in hot weather barbecues are more likely to be searched for and retailers websites will be more frequented. Therefore a maximum bid amount may be regularly manually or automatically updated on database 1021 based on changes in these factors, to be communicated to remote server 104 to update the user profile data stored thereon, to take into account these factors. Thus, when an auction takes place as a result of a user performing a search, an up to date maximum bid value is used by the advertising management system 1045 in determining which of its registered users will “win” an auction.

A special set of metadata attributes relating to the media content to be broadcast can be created, in the knowledge that transmission of the media content on a media channel will cause an increase in searches relating to keywords associated with the content, and an increase in traffic to websites with related subject matter to the media content.

Transmission of media content such as broadcast advertising is also known to affect metrics other than simple volume of website visitors. These metrics relate to the way in which users interact with web content. For example, “conversion rate” is a metric which is defined as the percentage of visitors who take or complete a desired action. This can be measured in clicks, or clicks to sale, and may result in increased sales and revenue. In order to maximise the conversion rate on a particular webpage or piece of online content, the advertising content presented to a user can be modified in this post transmission period, by having pre-defined attributes.

These attributes are referred to herein post-transmission attributes. The post-transmission attributes may contain non-standard creatives which relate to the subject matter of the media content. The post-transmission attributes will also contain bid-data which is determined based on the determined relevant ad groups and keywords associated with the media content.

The maximum bid data contained in the post transmission attributes is higher than the standard maximum bid value which is stored in the attributes database 1021.

Monitoring device 105 monitors the content transmitted via media channels 106, 108. Although the present embodiment includes two media channels 106, 108, it will be understood that the monitoring device 105 can monitor any number of media channels simultaneously, and the present embodiment is not limited to two channels. The monitoring device 105 compares media content transmitted on media channels 106, 108 with pre-identified media content. The media channels will typically be licensed broadcast channels, the transmit content in accordance with a predefined schedule. Examples include commercial television channels, such as ITV1, Sky One, Fox, CNN etc.

It will be understood that although remote server 104 is shown in FIG. 1 as being an individual server, there may be multiple remote servers, each storing potentially different user profile data and having a separate advertising management system 1045. Server 102 may communicate equally with one or more servers 104 to update user profile information which is specific to a particular provider of advertising management.

Remote server 104 comprises user profile data, stored in profile database 1040. The user profile data stored in database 1040 includes adgroups on which a user wishes to make a bid in a PPC auction, and a max bid amount. These data are used when an internet user makes a search via a search engine associated with remote server 104, or visits a website associated with remote server 104 which stores user profile data transmitted from server 102.

When server 102 receives a notification of transmission of the pre-identified media content on a media channel 106, 108, it retrieves the pre-identified ad groups and products that have been associated with the pre-identified media content. It then retrieves the associated media content metadata attributes from database 1021—i.e the post transmission attributes explained above which may contain specific post-transmission creatives, and an upweighted max bid amount associated with one or more ad groups.

Server 102 then communicates the post-transmission attributes to remote server 104 via the network 100. The communication of the post transmission attributes may take place through a Web-Service API or other suitable interface. The remote server 104 then writes the post-transmission attributes to the user profile data stored in profile database 1040. It is preferred that the process from detection of transmission of media content to communication of the post-transmission attributes to the remote server 104 takes place in less than 60 seconds, and even more preferably in less than 30 seconds.

When an online user subsequently performs a search including keywords relating to the ad groups having the post-transmission attributes, the advertising management system 1045 on remote server 104 uses the upweighted bid amounts in calculating the results of the online PPC auction, and subsequent position of search results. Likewise, when an internet user visits a webpage having content that has subject matter relating to the keywords and associated ad groups, the upweighted bid data is used in determining the position of advertising on the webpage.

The transmission of advertisement media content or program content results in a time window of increased interest in the subject matter related to the advertisement or program. The time period is variable dependent on the nature of the content, and the duration of the content, among other factors. The increased interest in the subject matter results in a higher volume of internet users searching for keywords and phrases related to the content, and increased traffic on content-websites hosting content similar to that contained in the transmission. Once this time window or time period has elapsed, interest in the subject matter will gradually return to pre-transmission levels.

Attributes database 1021 has pre-transmission attributes written to it prior to the communication of the post-transmission attributes to the remote server 104 via the network 100. The pre-transmission attributes may be requested or retrieved from the user-profile data stored on the user profile database, or may be stored from a previous communication of attributes to the remote server.

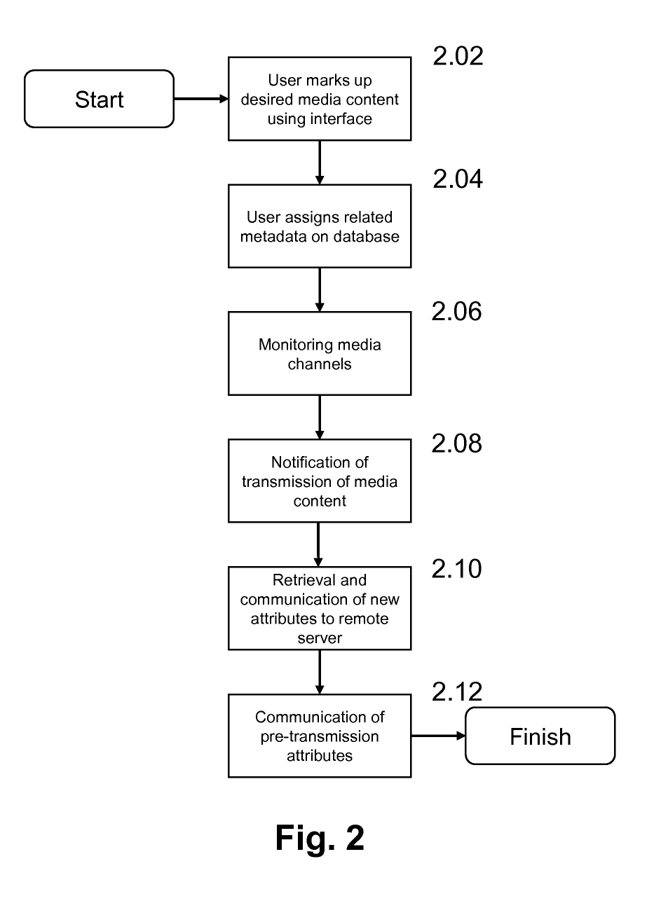

A flow chart showing an overview of the setup of an environment in which online content or data is dynamically modified in response to notification of transmission of media content on a media channel is shown in FIG. 2.

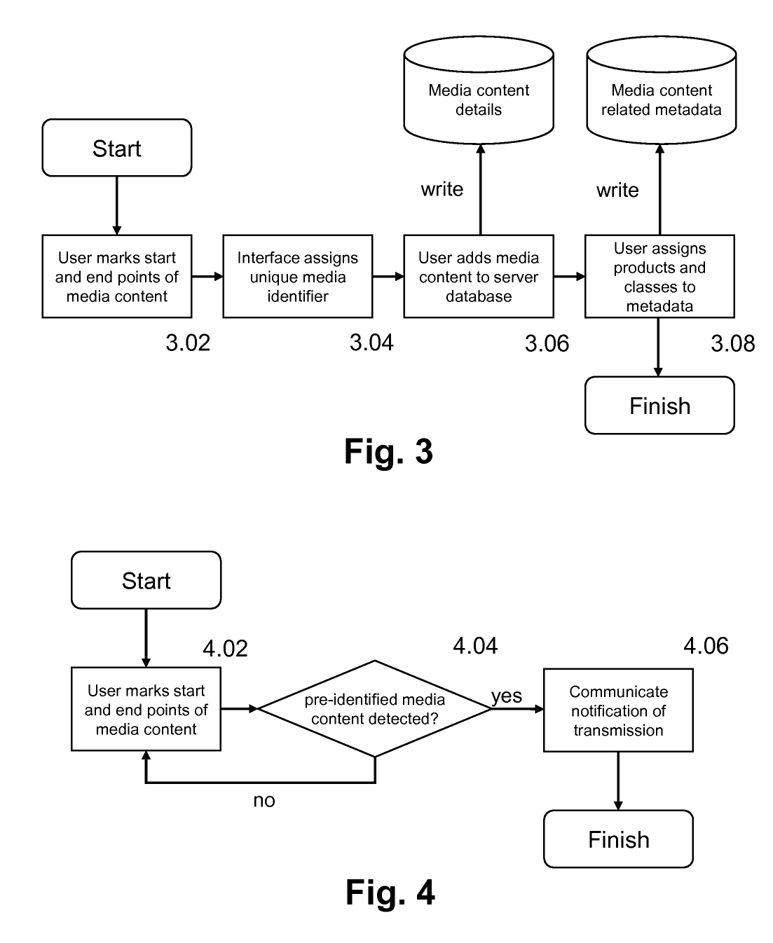

A system user, who may be an online merchant, sets up the monitoring system by identifying media content that will be transmitted on a media channel, in step 2.02. The media content may be selected from a group comprising a television advert, a radio advert, a television ident, an online video advert. Then, in step 2.04, the user defines the products and classes of products (known as ad groups) which relate to the subject matter of the media content. Values are written to the metadata attributes that relate to these products and ad groups, and are also written to the post-transmission attributes. These two steps are described in more detail below, with reference to FIG. 3.

In step 2.06 monitoring device 105 monitors media channels 106, 108, and notifies server 102 upon detecting the pre-identified media content in step 2.08. These two steps are outlined below in the description of FIG. 4.

Upon receipt of the notification of transmission of the media content, in step 2.10 the server 102 retrieves the post-transmission attributes from attributes database 1021 and communicates a message to a remote server 106 in step 2.12. The server 102 waits until a pre-determined time period has elapsed, and then communicates a second message comprising the pre-transmission attributes, to revert to the state before transmission.

FIG. 3 is a flow chart showing how the setup of a system which can perform a method as outlined in the present disclosure may be achieved. Firstly, in step 3.02 start and end points are assigned to the media content within a User Interface (UI) associated with the monitoring system.

The UI may be accessed from server 102 via a Web API, or the details may be provided to the monitoring device 105 in another manner—ie via email or other means. A unique media identifier (UMID) is assigned to the media content in step 3.04, and communicated to the server 102. The media content is added to a database (not shown in FIG. 1) in communication with Server 102 in step 3.06. in step 3.08, the metadata database 1020 and attribute database 1021 are then populated with the relevant data. In particular, details of products and classes of products associated with the subject matter of the media content are added to metadata database 1020. Keywords and creatives are populated into the attributes database, including the post-transmission attributes which contain modified creatives, and upweighted bid data.

The monitoring process is outlined in FIG. 4. The actual monitoring of the media channels is carried out using a device of the type provided by Ideas Unlimited (IU.TV Ltd, of Farnham, Surrey, UK) in the Contentprobe range (Further details are available at www.ideasunlimited.tv). The Contentprobe system provides real-time comparison of content being transmitted on multiple media channels and checks against stored data for the content, aspect ratio and audio presence and faults. As stated above, and shown in step 4.02 the content is marked up and the monitoring device takes a fingerprint of the media content. This fingerprint is unique to each individual item of media content.

In step 4.04, the monitoring device monitors selected media channels, as by running a fingerprint comparison for an instance of transmission of the marked-up and fingerprinted media content. When a successful match is obtained, indicating that the predefined media content has been transmitted, the monitoring device transmits a notification of transmission to server 102 via the network, in step 4.06. The notification is transmitted via a web API which communicates with the server without the need for user input. The notification of transmission could also be transmitted via other means, for example via SNMP, where the monitoring device is being used locally to the server 102.

The notification of transmission of the pre-identified media content includes the UMID assigned to the media content during the setup process, the start time of the transmission, the duration of the media content, and the channel ID of the channel upon which transmission was detected.

The notification via Web-API is carried out using the HTTP POST method in either JSON or XML format.

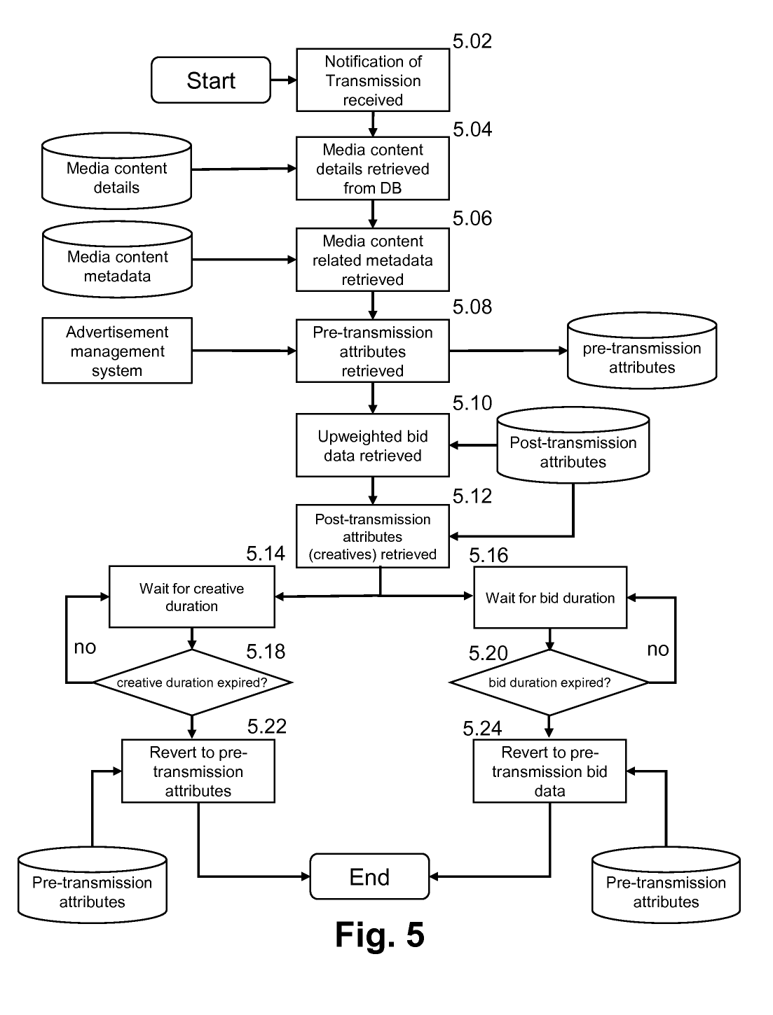

In FIG. 5, a flow diagram of a process is shown for the dynamic modification of user profile data for use by an advertisement management system, according to an embodiment of the present disclosure.

In step 5.02 of process 500, a notification is received at server 102, from monitoring system 105. The notification includes information relating to the transmission of pre-defined media content on a media channel, including a predefined UMID, the start time of the transmission of the media content, the duration of the media content, and a media channel identifier.

In step 5.04 server 102, or more precisely a processor forming part thereof, looks up details of the accounts or user groups requiring changes based on transmission of the media content.

In step 5.06, server 102 retrieves campaigns or classes of products (ad groups) which should be affected by the transmission of the media content from metadata database 1020.

In step 5.08, the processor of server 102 retrieves media content metadata attributes including keywords, creatives and bid data which are stored on remote server 104 as user profile data relating to the Ad groups retrieved in step 506. This data is retrieved via a Web-Service API. The retrieved attributes are written to pre-transmission attributes and stored in attribute database 1021. Alternatively, not shown in FIG. 5, the pre-transmission attributes can be written to a database prior to the notification.

In step 5.10, the processor of server 102 retrieves upweighted bid data from database 1021. The upweighted bid data is regularly recalculated according to various factors which influence the tendencies of internet users and click-through rate of a particular online advert.

In step 5.12, the processor of server 102 retrieves post-transmission keywords and creatives from the attribute database 1021. The processor of server 102 also retrieves two values for time periods relating to the duration for which upweighted bid data and the other post-transmission attributes are to be applied by the advertising management system 1045 of remote server 104. These time periods may be labelled bid duration and creative duration, and their values are calculated independently of the notification process shown in FIG. 5.

In a further step (not shown), the processor communicates the retrieved upweighted bid data and post transmission keywords and attributes to remote server 104 via the network 100. This may take place via a Web API. This communication including the post-transmission attributes between the server 102 and remote server 104 is written into user profile data at the remote server 104. The user profile data is for use by an advertising management system 1045, which uses the upweighted bid data in PPC auctions relating to keyword searches that are performed by internet users using search engines which relate to the classes of related products identified in the setup process. The post-transmission creatives will be applied by advertising management system 1045 where an associated advertisement is displayed on a webpage as a result of a successful auction bid, in the case of a Search Engine Results Page, and also in the case of display advertising. The webpage on which the display takes place may be a Search Engine Results Page, or a content webpage which includes display advertising content. The term Search Engine Results Page is used herein to denote any page which is reached following a user entering search terms which comprise keywords or phrases, and may include shopping results, webpage results etc.

In steps 5.14 to 5.20 the processor on server 102 then waits until either of the two time periods retrieved in step 5.12 have elapsed.

Once the time period for which the upweighted bid-data is to be applied has elapsed, processor on sever 102 retrieves the pre-transmission bid data and communicates via the network a message to the remote server 104, instructing that the pre-transmission bid data be written over the post-transmission bid data for subsequent use by the advertising management system 104, shown in step 5.24.

Once the time period for which the other post-transmission attributes are to be applied by the advertising management system 1045 has elapsed, the processor retrieves the pre-transmission attributes not including the bid data and communicates via the network a message to the remote server 104, instructing that the pre-transmission attributes data be written over the post-transmission attributes, for subsequent use by the advertising management system 1045, shown in step 5.22.

It will be appreciated that the two time periods calculated for the creative duration and the bid duration may be the same, in which case the communication instructing remote server to write over the post-transmission attributes and bid data can include both bid data and the other pre-transmission attributes, meaning steps 5.14 and 5,16, 5.18 and 5.20, 5.22 and 5.24 may be combined.

The process is complete once the pre-transmission attributes have been written back to the user profile data for use by the advertising management system 1045.

The process seen in FIG. 5 also can be used in an embodiment where bid data is not required. An example of such an embodiment is when the user wishes simply to modify the content of a proprietary webpage or other web content in response to notification of transmission of pre-defined media content.

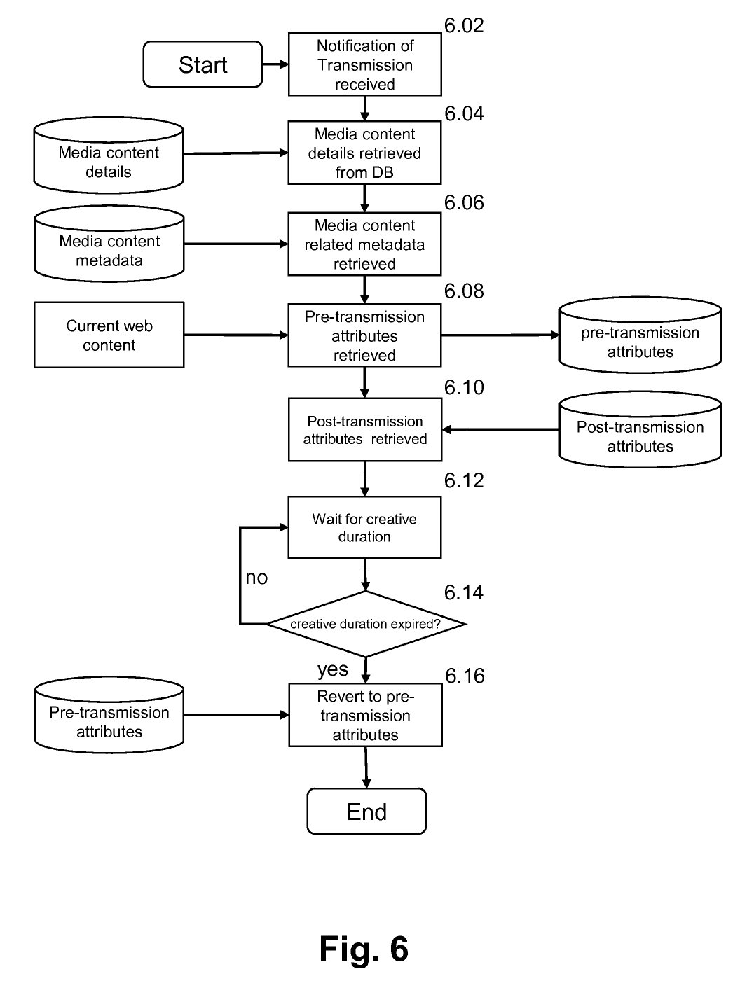

In this embodiment, shown in FIG. 6, the pre-transmission attributes are taken from the web-content, in step 6.08, and written to a database. Step 6.08 may optionally be performed periodically prior to the notification of transmission, so that the pre-transmission attributes are kept up to date on the database, thus speeding up the process shown in FIG. 6.

Once post-transmission attributes have been retrieved, in step 6.10, the web content is adapted in dependence on these attributes (not shown in FIG. 6). The adaptation may take place remotely, or the adaption may be instructed. Instructing the adaption of web content may take place via a Web-Service API or other similar means. This step results in, for example, the updating of a user's webpage, or some aspect of it, to include the post-transmission attributes.

The post transmission attributes can pertain to any aspect of web content, including but not limited to text data, hypertext data, image data or audio data. For example, once notification of transmission is received a web page can be modified to display different text, perhaps relating to special offers; new links to promotional material relating to the broadcast media content can be displayed; new images or videos relating to the media content may be displayed; or audio content relating to the transmitted media content may be embedded into web content.

The notification of transmission of media content and subsequent retrieval of post transmission attributes may be used to implement any computer implemented marketing or advertising activity. The marketing activity may include sending of a mailshot, or triggering of an email marketing campaign.

Various modifications to the above described embodiments, whether by way of addition, deletion or substitution, will be apparent to the skilled person to provide additional embodiments, any and all of which are intended to be encompassed by the appended claims.

What is claimed is:

1. A method comprising:
receiving, by a processor on a server, a notification of transmission of predefined media content on a media channel;
retrieving from a database media content metadata associated with the transmitted media content, wherein the retrieved metadata relates to products or services or classes of products or services relating to the transmitted media content, and the retrieved metadata comprises post-transmission attributes which are selected from a group comprising: text data, hypertext data, key words, key phrases, image data, audio data, video data and bid data; and
transmitting to a remote server a first message comprising the post-transmission attributes, wherein the remote server writes the post-transmission attributes to user-profile data for use by an advertising management system.

2. The method of claim 1, wherein the post-transmission attributes comprise bid data, and the advertising management system performs an auction using the post-transmission bid data written in the user-profile data.

3. The method of claim 2, wherein the auction relates to a search engine results page.

4. The method of claim 2, wherein the auction relates to a display advertisement.

5. The method of claim 1, wherein the notification of transmission is notification of broadcast on a television channel.

6. The method of claim 1, wherein the notification is received from a Web Service API, and the first message is transmitted to the remote server via a Web-Service API.

7. The method of claim 1, wherein the media content metadata further comprises pre-transmission attributes which are selected from a group comprising: keywords, keyphrases, image data, video data, and bid data.

8. The method of claim 7, further comprising transmitting a second message containing the pre-transmission attributes to the remote server.

9. The method of claim 8, wherein the second message is transmitted after a predetermined time period has elapsed since the receipt of notification of transmission.

10. The method of claim 1, wherein the first message is transmitted within 60 seconds of the transmission of the media content.

11. The method of claim 1, wherein the notification of transmission includes a unique identifier related to the media content, the time of transmission, and a media channel identifier.

12. A method comprising: monitoring transmission on one or more media channels for pre-identified media content;
transmitting a message via a Web-API to a remote server when pre-identified media content is detected; wherein the message comprises a unique identifier related to the media content.

13. The method of claim 12, wherein pre-identification of the media content includes analysing the media content for a digital fingerprint, and monitoring transmission includes fingerprint comparison between the pre-identified digital fingerprint and the digital fingerprint of the transmitted media content.

14. The method of claim 12, wherein the message further contains: the start time of media content transmission.

15. The method of claim 12, wherein the message further comprises a media channel identifier.

16. The method of claim 12, wherein the message is in JSON format.

17. A method comprising:
receiving, by a processor operating on a server, a notification of transmission of predefined media content on a media channel;
implementing by a processor operating on a server, computer-implemented marketing activity in dependence on the notification of transmission.

18. The method of claim 17, wherein the computer-implemented marketing activity is an email-based marketing campaign.

19. The method of claim 17, wherein the implementing further comprises:
retrieving from a database media content metadata associated with the transmitted media content, wherein the retrieved metadata relates to products and services or classes of products and services relating to the transmitted media content, and the retrieved metadata comprises post transmission attributes which are selected from a group comprising text data, hypertext data, image data and audio data, and
adapting, or instructing the adaptation of, web content in dependence on the post-transmission attributes.

20. The method of claim 19, wherein instructing the adaptation of the web content comprises instructing via a Web-Service API the application of the post-transmission attributes to web content.

21. An apparatus comprising:
computing device, having a processor or processors arranged to perform operations, comprising:
receiving a notification of transmission of media content on a media channel;
retrieving from a database media content metadata associated with the predefined media content, wherein the metadata relates to media content related products or classes thereof, and the metadata has assigned post-transmission attributes which are selected from a group comprising: keywords, keyphrases, image data, video data and bid data; and
transmitting to a remote server a first message comprising the post-transmission attributes, wherein the remote server writes the post-transmission attributes to user-profile data which is for use by an advertising management system.
